(19) United States
(12) Patent Application Publication
(10) Pub. No.: US 2006/0247347 A1
(43) Pub. Date: Nov. 2, 2006

(54) Waterborne pigment formulations

(75) Inventors: Martin Glos, Essen (DE); Hendrik Ahrens, Frankfurt am Main (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant Produkte (Deutschland) GmbH)

(21) Appl. No.: 11/408,726

(22) Filed: Apr. 21, 2006

(30) Foreign Application Priority Data
Apr. 28, 2005 (DE) 102005019747.7

(51) Int. Cl. C08K 5/23

(52) U.S. Cl. 524/190

(57) ABSTRACT

Aqueous pigment formulations comprise (A) at least one organic and/or inorganic pigment,
(B) at least one polymeric dispersant of the formula I, 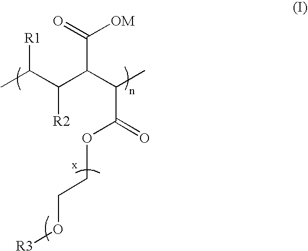 where
R¹ is aliphatic, linear or branched hydrocarbyl having 8 to 30 carbon atoms or a hydrogen atom,
R² is aliphatic, linear or branched hydrocarbyl having 8 to 30 carbon atoms or a hydrogen atom,
R³ is hydrocarbyl having 1 to 6 carbon atoms, n is an integer of not less than 3, x is an integer from 1 to 150, and M is a cation,
   with the proviso that one of R¹ and R² is hydrogen.

The present invention relates to waterborne pigment formulations, to a process for their production, to their use for coloring macromolecular materials of any kind, for example fiber materials, paper pulp coloration, coatings, paints, inks, and to their use for printing two-dimensional sheetlike constructions such as for example paper, card, plastics, textiles and leather.

Pigment formulations have for many years been produced using novolaks. EP-B-0 065 751 describes the use of novolaks for pigment formulations characterized in that they contain high pigment concentrations and are shear stable and storage stable. Novolaks are undesirable these days because of the secondary components such as alkylphenols and alkylphenol ethoxylates they contain, and their use is restricted by EC Directive 2003/53.

The present invention therefore has for its object to provide aqueous pigment formulations without novolaks that fulfill the following slate of requirements: the pigment formulations should possess high shear or flocculation stability. The concentration of pigments in the formulations should be very high, generally being not less than 20% by weight. The pigment formulations shall possess a high color strength, precisely defined coloristics with regard to hues and cleanness, a high colorfastness to light, a high bleed resistance and low viscosity. A storage stability of at least two years is desired; that is, the dispersed pigments shall not agglomerate and sediment within this time. In addition, the pigment dispersions shall possess high purity.

Ecotoxicologically impeccable pigment dispersions are substantially waterborne, containing by way of organic solvents only those whose boiling point is above 250° C. and which accordingly do not count as volatile organic components.

We have found that this object is achieved, surprisingly, by using dispersing agents based on a carboxylate of a monomaleate ester with an α-olefin to produce aqueous pigment formulations that meet the quality requirements discussed above. The aqueous pigment dispersions hereinbelow are stable to shearing, resist drying out, are stable in storage, foam little in use, if at all, and possess excellent rheology.

The present invention accordingly provides aqueous pigment formulations comprising
(A) at least one organic and/or inorganic pigment,
(B) at least one polymeric dispersant of the formula I, 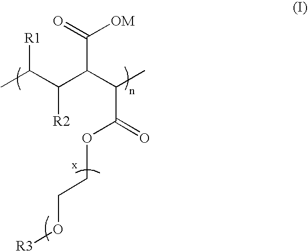
   where
      R¹ is aliphatic, linear or branched hydrocarbyl having 8 to 30 carbon atoms or a hydrogen atom,
      R² is aliphatic, linear or branched hydrocarbyl having 8 to 30 carbon atoms or a hydrogen atom,
   R³ is hydrocarbyl having 1 to 6 carbon atoms,
      n is an integer of not less than 3,
      x is an integer from 1 to 150, and
      M is a cation,
with the proviso that one of R¹ and R² is hydrogen.
R³ is preferably methyl, ethyl, propyl, butyl, pentyl or hexyl.
n is preferably an integer from 4 to 1000, especially from 5 to 500 and specifically from 6 to 100.

Preferably, M is sodium, potassium, ammonium, ethanolammonium, triethanolammonium or trimethylammonium.

As well as the constituents (A) and (B), the composition of the present invention may comprise further constituents. The composition of the present invention thus comprises in preferred embodiments

if appropriate one or more nonionic surfactants from the group of the alkylphenol polyethylene glycol ethers, styrene-substituted phenol polyethylene glycol ethers, alkyl polyethylene glycol ethers, fatty acid polyethylene glycol ethers, fatty acid polyglycosides, alkyl polyalkyl glycol ethers of C₈-C₂₂-alcohols that have been blockwise reacted with ethylene oxide and propylene oxide, end group capped alkyl ethoxylates of C₈-C₂₂-alcohols that have been reacted with ethylene oxide and etherified with methyl chloride, butyl chloride or benzyl chloride, ethylene/propylene glycol block polymers and sorbitan ester polyethylene glycol ethers;

if appropriate one or more anionic surfactants from the group of the sodium, potassium and ammonium salts of fatty acids, sodium alkylbenzene sulfonates, sodium alkylsulfonates, sodium olefinsulfonates, sodium polynaphthalenesulfonates, sodium dialkyl diphenyl ether disulfonates, sodium, potassium and ammonium alkyl sulfates, sodium, potassium and ammonium alkyl polyethylene glycol ether sulfates, sodium, potassium and ammonium alkylphenol polyethylene glycol ether sulfates, sodium, potassium and ammonium mono- and dialkyl sulfosuccinates and monoalkyl polyoxyethyl sulfosuccinates, and also alkyl polyethylene glycol ether phosphoric mono-, di- and triesters and mixtures thereof and alkylphenol polyethylene glycol ether phoshoric mono-, di and triesters and mixtures thereof, and also their sodium, potassium and ammonium salts, alkyl polyethylene glycol ether carboxylic acids and their sodium, potassium and ammonium salts, sulfuric acid monoesters and phosphoric esters of styrene-substituted phenol ethoxylates, styrene-substituted phenol polyethylene glycol ether carboxylic acids and their sodium, potassium and ammonium salts, sodium fatty acid isethionates, sodium fatty acid methyltaurides and sodium fatty acid sarcosides;
(E) if appropriate one or more polyethylene glycol ethers having an average molar mass between 200 and 2000 g/mol;
(F) if appropriate one or more polyethylene glycol monoalkyl ethers having an average molar mass between 200 and 2000 g/mol and an alkyl radical of 1-6 carbon atoms;
(G) if appropriate one or more organic solvents or one or more hydrotropic substances;
(H) if appropriate further additives customary for aqueous pigment formulations;
(J) if appropriate a preservative; and
(K) water.

The constituents (A) to (K) are preferably present in the following amounts:
(A) 3% to 80% by weight, preferably 20% to 70% by weight and especially 30% to 50% by weight of at least one organic and/or inorganic pigment.
(B) 0.1% to 30% by weight and preferably 1% to 15% by weight of at least one compound of formula I.
(C) 0% to 30% by weight and preferably 1% to 15% by weight of a nonionic surfactant.
(D) 0% to 30% by weight and preferably 1% to 15% by weight of an anionic surfactant.
(E) 0% to 50% by weight and preferably 1% to 20% by weight of a polyethylene glycol ether having an average molar mass between 200 and 2000 g/mol.
(F) 0% to 50% by weight and preferably 1% to 20% by weight of a polyethylene glycol monoalkyl ether having an average molar mass between 200 and 2000 g/mol and an alkyl radical of 1-6 carbon atoms.
(G) 0% to 30% by weight and preferably 0% to 20% by weight of an organic solvent or of a hydrotropic substance.
(H) 0% to 10% by weight and preferably 0% to 5% by weight of further additives customary for aqueous pigment formulations.
(J) 0% to 2% by weight and preferably 0.02% to 0.05% by weight of a preservative.
(K) 5% to 90% by weight and preferably 10% to 70% by weight of water.

The weight percentages are each based on the total weight of the pigment formulation.

When one or more of the components (C), (D), (E), (F), (G), (H) and (J) are present, their minimum concentration is independently advantageously at least 0.01% by weight and preferably at least 0.1% by weight, based on the total weight of the pigment formulation.

Component (A) of the pigment formulation of the present invention is a finely divided organic or inorganic pigment or a mixture of various organic and/or inorganic pigments. The pigments can be used not only in the form of dry powder but also as water-moist presscake.

Useful organic pigments include monoazo, disazo, laked azo, β-naphthol, Naphthol AS, benzimidazolone, disazo condensation, azo metal complex pigments and polycyclic pigments such as for example phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline and diketopyrrolopyrrole pigments or carbon blacks.

Of the organic pigments mentioned, those whose colorfastness to light is rated higher than 5 and especially higher than 6 against a blue standard are particularly suitable. In addition, the pigments used for producing the formulations should be in a very fine state of subdivision where preferably 95% and more preferably 99% of the pigment particles are ≦500 nm in size.

An exemplary selection of particularly preferred organic pigments includes carbon black pigments, for example lamp or furnace blacks; monoazo and disazo pigments, in particular the Colour Index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34 or Pigment Brown 41; β-naphthol and Naphthol AS pigments, in particular the Colour Index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38 or Pigment Brown 1; laked azo and metal complex pigments, in particular the Colour Index pigments Pigment Red 48:2, Pigment Red 48:3, Pigment Red 48:4, Pigment Red 57:1, Pigment Red 257, Pigment Orange 68 or Pigment Orange 70; benzimidazoline pigments, in particular the Colour Index pigments Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72 or Pigment Brown 25; isoindolinone and isoindoline pigments, in particular the Colour Index pigments Pigment Yellow 139 or Pigment Yellow 173; phthalocyanine pigments, in particular the Colour Index pigments Pigment Blue 15, Pigment Blue 15:1, Pigment Blue 15:2, Pigment Blue 15:3, Pigment Blue 15:4, Pigment Blue 15:6, Pigment Blue 16, Pigment Green 7 or Pigment Green 36; anthanthrone, anthraquinone, quinacridone, dioxazine, indanthrone, perylene, perinone and thioindigo pigments, in particular the Colour Index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23 or Pigment Orange 43; triarylcarbonium pigments, in particular the Colour Index pigments Pigment Red 169, Pigment Blue 56 or Pigment Blue 61; diketopyrrolo-pyrrole pigments, in particular the Colour Index pigments Pigment Red 254.

Useful inorganic pigments include for example titanium dioxides, zinc sulfides, iron oxides, chromium oxides, ultramarine, nickel antimony titanium oxides, chromium antimony titanium oxides, cobalt oxides, mixed oxides of cobalt and of aluminum, bismuth vanadates and also blend pigments.

Instead of pigment dispersions it also possible to prepare dispersions of solids including for example finely divided ores, minerals, sparingly soluble or insoluble salts, particles of wax or plastic, dyes, crop protection and pesticide control agents, UV absorbers, optical brighteners and polymerization stabilizers.

Component (B) is typically used as an aqueous solution for producing the pigment formulations of the present invention. Component (B) is obtained by bulk polymerization of an α-olefin with maleic anhydride in the presence of a free-radical polymerization initiator. The resulting α-olefin-maleic anhydride copolymer is subsequently reacted with a polyethylene glycol monoalkyl ether to form a monoester and neutralized with a suitable base in water. The polyethylene glycol monoalkyl ether preferably contains 1-150 ethylene glycol units and an alkyl radical of 1-6 carbon atoms. EP 0 181 037 describes the preparation of component (B).

Component (G) is water-soluble, organic or hydrotropic substances. Such compounds, which also serve as a solvent, if appropriate, may be for example formamide, urea, tetramethylurea, ε-caprolactam, ethylene glycol, propylene glycol, diethylene glycol, triethylene glycol, polyethylene glycol, butylglycol, glycerol, N-methylpyrrolidone, 1,3-diethyl-2-imidazolidinone, thiodiglycol, sodium benzenesulfonate, sodium xylenesulfonate, sodium toluenesulfonate, sodium cumenesulfonate, sodium dodecylsulfonate, sodium benzoate, sodium salicylate or sodium butyl monoglycol sulfate.

Useful additives (component H) include further cationic, anionic, amphoteric or nonionic surfactants and pigment-wetting agents, and also antisettling agents, photoprotectants, antioxidants, degassers/defoamers, foam-reducing agents, fillers, grinding assistants, viscosity stabilizers and rheology improvers. Useful viscosity regulators include for example polyvinyl alcohol and cellulose derivatives. Water-soluble natural or artificial resins and also polymers may similarly be included as filming or binding agents to enhance bonding strength and abrasion resistance. Useful pH regulators include organic or inorganic bases and acids. Preferred organic bases are amines, for example ethanolamine, diethanolamine, triethanolamine, N,N-dimethylethanolamine, diisopropylamine, aminomethylpropanol or dimethylaminomethylpropanol. Preferred inorganic bases are sodium hydroxide, potassium hydroxide, lithium hydroxide or ammonia.

Water used as components (K) to produce the pigment formulations is preferably used in the form of distilled or demineralized water. It is similarly possible to use tapwater and/or water of natural origin.

The pigment formulations of the present invention are miscible with water in any proportion, even a plurality of different formulations being miscible with water. Compared with conventional pigment formulations, they possess excellent shear stability. The pigment formulations possess good stability in storage and have very little tendency to agglomerate and sediment. The pigment formulations possess high color strength, defined hues, high colorfastness to light, high bleed resistance and low viscosity featuring good rheological properties and approximately newtonian flow characteristics.

The present invention also provides a process for producing the pigment formulations of the present invention, which comprises dispersing component (A) in the form of a powder, a granulate or an aqueous presscake in the presence of water (K) and also of component (B) and if appropriate (C), (D), (E), (F), (G), (H) and (J) in a conventional manner, then admixing water (K), if appropriate, and adjusting the resulting aqueous pigment dispersion with water to the desired concentration. Preferably, the components (B), (C), (D), (E), (F), (G), (H), (J) and (K) are mixed and homogenized and then component (A) is stirred into the initially charged mixture, causing the pigment to become incipiently pasted and predispersed. The predispersion is subsequently, depending on the texture of the pigments used, finely dispersed or finely dissipated, with or without cooling, using a grinding or dispersing assembly. They include stirrers, dissolvers (sawtooth stirrers), rotor-stator mills, ball mills, stirred media mills such as sand and bead mills, high speed mixers, kneaders, roll mills or high performance bead mills. The pigments are finely dispersed or ground to the desired particle size distribution, at temperatures ranging for example from 0 to 100° C., advantageously between 10 and 70° C. and preferably at 20 to 60° C. Following the operation of fine dispersion, the pigment formulation may be further diluted with water, preferably deionized or distilled water.

The pigment formulations of the present invention are useful for pigmenting and dyeing macromolecular materials of any kind, for example natural and synthetic fiber materials, preferably cellulose fibers, especially for textile dyeing and textile printing.

The pigment formulation of the present invention is further useful for pigmentation or production of painting and emulsion colors, emulsion paints, solventborne printing inks, including for example printing inks for textile, flexographic, decorative or gravure printing, wallpaper colors, water-thinnable paints, wood preservation systems, dyeing systems for viscose, varnishes, sausage casings, seed, fertilizers, glass bottles, and also for mass coloration of roof shingles, for coloring floor renders, woodstains, colored pencil leads, fibertip pens, waxes, paraffins, graphics inks, ballpoint pen pastes, chalks, washing and cleaning compositions, shoe care agents, latex products, abrasives, and also for coloring plastics or high molecular weight materials. High molecular weight organic materials are for example cellulose ethers and esters, such as ethylcellulose, nitrocellulose, cellulose acetate or cellulose butyrate, natural resins or artificial resins, such as addition polymerization resins or condensation resins, for example amino resins, especially urea- and melamine-formaldehyde resins, alkyd resins, acrylic resins, phenolic resins, polycarbonates, polyolefins, such as polystyrene, polyvinyl chloride, polyethylene, polypropylene, polyacrylonitrile, polyacrylic esters, polyamides, polyurethanes or polyesters, rubber, casein, latices, silicone, silicone resins, individually or in admixture.

The pigment formulations of the present invention are further useful for producing printing inks for use in all conventional ink jet printers, particularly for those based on the bubble jet or piezo process. These printing inks can be used to print paper and also natural or synthetic fiber materials, foils and plastics. Additionally the pigment formulations of the present invention can be used for printing various kinds of coated or uncoated substrate materials, for example for printing paperboard, cardboard, wood and woodbase materials, metallic materials, semiconductor materials, ceramic materials, glasses, glass and ceramic fibers, inorganic materials of construction, concrete, leather, comestibles, cosmetics, skin and hair. The substrate material may be two-dimensionally planar or spatially extended, i.e., three-dimensionally configured, and may be printed or coated completely or only in parts.

The pigment formulations of the present invention are further useful as a colorant in electrophotographic toners and developers, for example in one- or two-component powder toners (also called one- or two-component developers), magnetic toners, liquid toners, latex toners, polymerization toners and also specialty toners. Typical toner binders in this context are addition polymerization resins, polyaddition resins, polycondensation resins, such as styrene, styrene-acrylate, styrene-butadiene, acrylate, polyester, phenol-epoxy resins, polysulfones, polyurethanes, individually or in combination, and also polyethylene and polypropylene, which may each contain further ingredients, such as charge control agents, waxes or flow assistants, or may be subsequently modified with these adjuvants.

The pigment formulations of the present invention are also useful as a colorant in powders and powder coatings, especially in triboelectrically or electrokinetically sprayable powder coatings, which are used to coat the surfaces of articles made for example of metal, wood, plastic, glass, ceramic, concrete, textile material, paper or rubber. Powder coating resins used here are typically epoxy resins, carboxyl- and hydroxyl-containing polyester resins, polyurethane resins and acrylic resins, together with the customary hardeners. Combinations of resins are also used. For instance, epoxy resins are frequently used in combination with carboxyl- and hydroxyl-containing polyester resins. Examples of typical hardener components (depending on the resin system) are acid anhydrides, imidazoles and also dicyandiamide and derivatives thereof, capped isocyanates, bisacylurethanes, phenolic resins, melamine resins, triglycidyl isocyanuarates, oxazolines and dicarboxylic acids.

The pigment formulations of the present invention are also useful as a colorant in inks, preferably ink jet inks, such as for example those on an aqueous or nonaqueous basis, microemulsion inks, UV-curable inks and also in inks which operate by the hot melt process.

### EXAMPLES

Production of a Pigment Formulation

The pigment, in the form alternatively of powder, granulate or presscake, is pasted in deionized water together with the dispersants and the other adjuvants and then homogenized and predispersed using a dissolver (for example from VMA-Getzmann GmbH, type AE3-M1) or some other suitable apparatus. Fine dispersion is subsequently effected using a bead mill (for example AE3-M1 from VMA-Getzmann) or else some other suitable dispersing assembly, with milling being carried out with siliquartzite beads or zirconium mixed oxide beads of size d=1 mm, accompanied by cooling, until the desired color strength and coloristics are obtained. Thereafter, the dispersion is adjusted with deionized water to the desired final pigment concentration, the grinding media separated off and the pigment formulation isolated.

The pigment formulations described in the examples which follow were produced by the method described above, the following constituents being used in the stated amounts so as to produce 100 parts of the respective pigment formulation. Parts are by weight in the examples below.

### Example 1

| | | |
|---|---|---|
| 35 | parts | of C.I. Pigment Blue 15:1 |
| | | (®Hostaperm Blau A2R, component A), |
| 10 | parts | of dispersant of formula (I) where |
| | | R¹ = C₁₂/C₁₄-alkyl, R² = methyl, x = 7-8, |
| | | M = Na⁺ (component B), |
| 2 | parts | of alkyl polyalkylene glycol ether (component C), |
| 9.5 | parts | of polyethylene glycol, molecular |
| | | weight 200 g/mol (component E), |
| 1 | part | of defoamer (component H) |
| 0.2 | part | of preservative (component J), |
| 42.3 | parts | of completely ion-free water (component K) |

The components (B), (C), (E), (H) and (J) are charged to a grinding vessel and mixed. Then, the pulverulent component (A) is added and predispersed using the dissolver. The predispersion is finely dispersed in a bead mill using zirconium mixed oxide beads of size d=1 mm, with cooling. The grinding media is then separated off and the pigment formulation isolated. The pigment formulation is stored at 60° C. for one week and visually inspected. The viscosity of the pigment formulation is measured using a Brookfield Digital Viscometer Model DV-II at 100 revolutions per minute using spindle 4.

The pigment formulation is liquid, homogeneous and free of foam after one week of storage at 60° C. The viscosity of the pigment formulation is 68 mPa·s.

### Example 2

| | | |
|---|---|---|
| 30 | parts | of C.I. Pigment Red 122 |
| | | (®Hostaperm Rot E-WD, component A) |
| 5 | parts | of dispersant of formula (I) where |
| | | R¹ = C₁₂/C₁₄-alkyl, R² = methyl, x = 7-8, |
| | | M = Na⁺ (component B), |
| 2 | parts | of alkyl polyalkylene glycol ether (component C), |
| 9.5 | parts | of polyethylene glycol, molecular weight 200 g/mol |
| | | (component E), |
| 1 | part | of defoamer (component H) |
| 0.2 | part | of preservative (component J), |
| 52.3 | parts | of completely ion-free water (component K) |

The pigment formulation is prepared and tested as described under Example 1. The pigment formulation is liquid, homogeneous and free of foam after one week of storage at 60° C. The viscosity of the pigment formulation is 180 mPa·s.

### Example 3

| | | |
|---|---|---|
| 30 | parts | of C.I. Pigment Black 7 |
| | | (Spezial Schwarz 4 from Degussa AG, component A), |
| 5 | parts | of dispersant of formula (I) where |
| | | R¹ = C₁₂/C₁₄-alkyl, R² = methyl, x = 7-8, |
| | | M = Na⁺ (component B), |
| 2 | parts | of alkyl polyalkylene glycol ether (component C), |
| 9.5 | parts | of polyethylene glycol, molecular weight |
| | | 200 g/mol (component E), |
| 1 | part | of defoamer (component H) |
| 0.2 | part | of preservative (component J), |
| 52.3 | parts | of completely ion-free water (component K) |

The pigment formulation is prepared and tested as described under Example 1. The pigment formulation is liquid, homogeneous and free of foam after one week of storage at 60° C. The viscosity of the pigment formulation is 26 mPa·s.

### Example 4

| | | |
|---|---|---|
| 40 | parts | of C.I. Pigment Red 146 |
| | | (®Permanent Carmin FBB 02, component A), |
| 5 | parts | of dispersant of formula (I) where |
| | | R¹ = C₁₂/C₁₄-alkyl, R² = methyl, x = 7-8, |
| | | M = Na⁺ (component B), |
| 2 | parts | of alkyl polyalkylene glycol ether (component C), |
| 9.5 | parts | of polyethylene glycol, molecular weight |
| | | 200 g/mol (component E), |
| 1 | part | of defoamer (component H) |
| 0.2 | part | of preservative (component J), |
| 42.3 | parts | of completely ion-free water (component K) |

The pigment formulation is prepared and tested as described under Example 1. The pigment formulation is liquid, homogeneous and free of foam after one week of storage at 60° C. The viscosity of the pigment formulation is 300 mPa·s.

### Example 5

| | | |
|---|---|---|
| 30 | parts | of C.I. Pigment Violet 23 |
| | | (®Hostaperm Violet BL, component A), |
| 5 | parts | of dispersant of formula (I) where |
| | | R¹ = C₁₂/C₁₄-alkyl, R² = methyl, x = 7-8, |
| | | M = Na⁺ (component B), |
| 2 | parts | of alkyl polyalkylene glycol ether (component C), |
| 9.5 | parts | of polyethylene glycol, molecular weight |
| | | 200 g/mol (component E), |
| 1 | part | of defoamer (component H) |
| 0.2 | part | of preservative (component J), |
| 52.3 | parts | of completely ion-free water |
| | | (component K) |

The pigment formulation is prepared and tested as described under Example 1. The pigment formulation is liquid, homogeneous and free of foam after one week of storage at 60° C. The viscosity of the pigment formulation is 55 mPa·s.

### Example 6

| | | |
|---|---|---|
| 20 | parts | of C.I. Pigment Violet 19 |
| | | (®Hostaperm Rot E5B 02, component A), |
| 5 | parts | of dispersant of formula (I) where |
| | | R¹ = C₁₂/C₁₄-alkyl, R² = methyl, x = 7-8, |
| | | M = Na⁺ (component B), |
| 2 | parts | of alkyl polyalkylene glycol ether (component C), |
| 9.5 | parts | of polyethylene glycol, molecular weight |
| | | 200 g/mol (component E), |
| 1 | part | of defoamer (component H) |
| 0.2 | part | of preservative (component J), |
| 62.3 | parts | of completely ion-free water (component K) |

The pigment formulation is prepared and tested as described under Example 1. The pigment formulation is liquid, homogeneous and free of foam after one week of storage at 60° C. The viscosity of the pigment formulation is 53 mPa·s.

### Example 7

| | | |
|---|---|---|
| 40 | parts | of C.I. Pigment Red 184 |
| | | (®Permanent Rubin F6B, component A), |
| 8 | parts | of dispersant of formula (I) where |
| | | R¹ = C₁₂/C₁₄-alkyl, R² = methyl, x = 7-8, |
| | | M = Na⁺ (component B), |
| 2 | parts | of alkyl polyalkylene glycol ether (component C), |
| 9.5 | parts | of polyethylene glycol, molecular weight |
| | | 200 g/mol (component E), |
| 1 | part | of defoamer (component H) |
| 0.2 | part | of preservative (component J), |
| 29.3 | parts | of completely ion-free water (component K) |

The pigment formulation is prepared and tested as described under Example 1. The pigment formulation is liquid, homogeneous and free of foam after one week of storage at 60° C. The viscosity of the pigment formulation is 189 mPa·s.

### Example 8

| | | |
|---|---|---|
| 60 | parts | of C.I. Pigment Red 102 |
| | | (®Bayferrox130 from Bayer AG, component A), |
| 9 | parts | of dispersant of formula (I) where |
| | | R¹ = C₁₂/C₁₄-alkyl, R² = methyl, x = 7-8, |
| | | M = Na⁺ (component B), |
| 1 | part | of alkyl polyalkylene glycol ether (component C), |
| 0.2 | part | of preservative (component H), |
| 1 | part | of defoamer (component J) |
| 28.8 | parts | of completely ion-free water (component K) |

The pigment formulation is prepared and tested as described under Example 1. The pigment formulation is liquid, homogeneous and free of foam after one week of storage at 60° C. The viscosity of the pigment formulation is 70 mPa·s.

### Example 9

| | | |
|---|---|---|
| 60 | parts | of C.I. Pigment Red 102 |
| | | (®Bayferrox130 from Bayer AG, component A), |
| 9 | parts | of dispersant of formula (I) where |
| | | R¹ = C₁₈/C₂₂-alkyl, R² = methyl, x = ca. 25, |
| | | M = Na⁺ (component B), |
| 1 | part | of alkyl polyalkylene glycol ether (component C), |
| 1 | part | of defoamer (component H) |
| 0.2 | part | of preservative (component J), |
| 28.8 | parts | of completely ion-free water (component K) |

The pigment formulation is prepared and tested as described under Example 1. The pigment formulation is liquid, homogeneous and free of foam after one week of storage at 60° C. The viscosity of the pigment formulation is 76 mPa·s.

### Example 10

| | | |
|---|---|---|
| 60 | parts | of C.I. Pigment Yellow 42 |
| | | (®Bayferrox 3920 from Bayer AG, component A), |
| 9 | parts | of dispersant of formula (I) where |
| | | R¹ = C₁₈/C₂₂-alkyl, R² = methyl, x = ca. 45, |
| | | M = Na⁺ (component B), |
| 1 | part | of alkyl polyalkylene glycol ether (component C), |
| 1 | part | of defoamer (component H) |
| 0.2 | part | of preservative (component J), |
| 28.8 | parts | of completely ion-free water (component K) |

The pigment formulation is prepared and tested as described under Example 1. The pigment formulation is liquid, homogeneous and free of foam after one week of storage at 60° C. The viscosity of the pigment formulation is 147 mPa·s.

### Example 11

| | | |
|---|---|---|
| 60 | parts | of C.I. Pigment Black 11 |
| | | (®Bayferrox 316 from Bayer AG, component A), |
| 9 | parts | of dispersant of formula (I) where |
| | | R¹ = C₁₈/C₂₂-alkyl, R² = methyl, x = ca. 25, |
| | | M = Na⁺ (component B), |
| 1 | part | of alkyl polyalkylene glycol ether (component C), |
| 1 | part | of defoamer (component H) |
| 0.2 | part | of preservative (component J), |
| 28.8 | parts | of completely ion-free water (component K) |

The pigment formulation is prepared and tested as described under Example 1. The pigment formulation is liquid, homogeneous and free of foam after one week of storage at 60° C. The viscosity of the pigment formulation is 253 mPa·s.

### Example 12

| | | |
|---|---|---|
| 35 | parts | of C.I. Pigment Yellow 34 |
| | | (®Permanent Orange RL 70, component A), |
| 5 | parts | of dispersant of formula (I) where |
| | | R¹ = C₁₂/C₁₄-alkyl, R² = methyl, x = 7-8, |
| | | M = Na⁺ (component B), |
| 2 | parts | of alkyl polyalkylene glycol ether (component C), |
| 9.5 | parts | of polyethylene glycol, molecular weight |
| | | 200 g/mol (component E), |
| 1 | part | of defoamer (component H) |
| 0.2 | part | of preservative (component J), |
| 47.3 | parts | of completely ion-free water (component K) |

The pigment formulation is prepared and tested as described under Example 1. The pigment formulation is liquid, homogeneous and free of foam after one week of storage at 60° C. The viscosity of the pigment formulation is 275 mPa·s.

1. An aqueous pigment formulation comprising
(A) at least one organic or inorganic pigment, or a mixture thereof,
(B) at least one polymeric dispersant of the formula I, 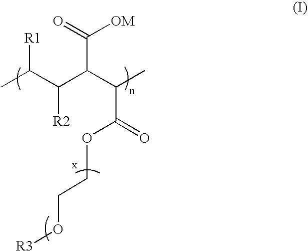
where
R¹ is aliphatic, linear or branched hydrocarbyl having 8 to 30 carbon atoms or a hydrogen atom,
R² is aliphatic, linear or branched hydrocarbyl having 8 to 30 carbon atoms or a hydrogen atom,
R³ is hydrocarbyl having 1 to 6 carbon atoms,
n is an integer of not less than 3,
x is an integer from 1 to 150, and
M is a cation,
with the proviso that one of R¹ and R² is hydrogen.

2. The pigment formulation according to claim 1 wherein R¹ or R² is alkyl.

3. The pigment formulation according to claim 1 wherein n is an integer from 4 to 1000.

4. The pigment formulation of claim 1, wherein M is selected from the group consisting of sodium, potassium, ammonium, ethanolammonium, triethanolammonium trimethylammonium, and mixtures thereof.

5. The pigment formulation of claim 1, wherein component A comprises 3% to 80% by weight.

6. The pigment formulation of claim 1, wherein component B) comprises 0.1% to 30% by weight.

7. The pigment formulation of claim 1, further comprising up to 30% by weight of a nonionic surfactant.

8. The pigment formulation of claim 1, further comprising up to 30% by weight of an anionic surfactant.

9. The pigment formulation of claim 1, further comprising 0% to 50% by weight of a polyethylene glycol ether having an average molar mass between 200 and 2000 g/mol.

10. The pigment formulation of claim 1, further comprising 0% to 50% by weight of a polyethylene glycol monoalkyl ether having an average molar mass between 200 and 2000 g/mol and an alkyl radical of 1-6 carbon atoms.

11. The pigment formulation of claim 1, further comprising 0% to 30% by weight of an organic solvent or of a hydrotropic substance.

12. The pigment formulation of claim 1, further comprising 0% to 10% by weight of further additives customary for aqueous pigment formulations.

13. The pigment formulation of claim 1, further comprising 0% to 2% by weight of a preservative.

14. A process for producing a pigment formulation, which comprises:
a) mixing
i) at least one organic or inorganic pigment or mixture thereof in the form of a powder, a granulate or an aqueous presscake being dispersed in the presence of water and
ii) at least one compound of formula I 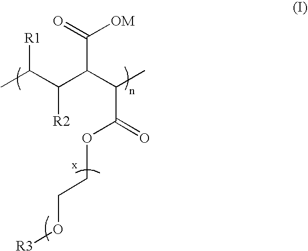
where
R¹ is aliphatic, linear or branched hydrocarbyl having 8 to 30 carbon atoms or a hydrogen atom,
R² is aliphatic, linear or branched hydrocarbyl having 8 to 30 carbon atoms or a hydrogen atom,
R³ is hydrocarbyl having 1 to 6 carbon atoms,
n is an integer of not less than 3,
x is an integer from 1 to 150, and
M is a cation,
with the proviso that one of R¹ and R² is hydrogen,
b) admixing an effective amount of water to provide the resulting aqueous pigment dispersion with water to a desired concentration.

15. (canceled)

16. A method for dyeing macromolecular materials, said method comprising contacting said macro molecular materials with the pigment formulation of claim 1.

17. A method for printing two-dimensional sheet construction, said method comprising contacting said two-dimensional sheet construction with the pigment formulation of claim 1.
